(19) United States
(12) Patent Application Publication
(10) Pub. No.: US 2009/0140865 A1
(43) Pub. Date: Jun. 4, 2009

(54) SOIL MOISTURE MONITORING APPARATUS AND METHOD

(76) Inventor: Metin Ata Gunsay, (US)

Correspondence Address: Metin Ata Gunsay, 136 E. Steep Mountain Dr., Draper, UT, 84020, US

(21) Appl. No.: 11/947,894

(22) Filed: Nov. 30, 2007

(51) Int. Cl. G08B 21/00

(52) U.S. Cl. 340/604

(57) ABSTRACT

A soil moisture or dryness monitoring apparatus and method, having a moisture sensor, multiplicity of LED drivers, and one or more multicolor LEDs. The sensor signal modulates the current output of the LED drivers such that the hue of the displayed color is proportional to the moisture content of the soil.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to moisture sensing; specifically to an improved moisture monitoring apparatus and method, which warns a caretaker of the degree to which a plant needs to be watered.

2. Prior Art

For many individuals remembering to consistently water a houseplant is a difficult task. If not watered or watered inconsistently, a plant will die or become unattractive.

Several devices have been developed which use various methods of indication, to alert a caretaker the adequacy or inadequacy of soil moisture. For Example, U.S. Pat. No. 4,791,413, uses a beeper to alert, U.S. Pat. No. 4,268,824 uses a blinking LED, U.S. Pat. No. 4,514,722 uses a beeper and a blinking LED, U.S. Pat. No. 4,931,775 plays an audible tune, U.S. Pat. No. 6,202,479 forms the sensor into a decretive animal shape and plays corresponding animal noise. These devices fail to indicate the degree of dryness or wetness of the soil.

Several devices have been developed which show the degree of dryness. For Example, U.S. Pat. No. 6,198,398, blinks a single LED at a rate that becomes increasingly fast as the soil becomes more dry. As batteries generally power these devices, this approach of rapidly blinking an LED will quickly dissipate a battery. In addition, a rapidly blinking LED can become intrusive and an annoyance to the caretaker. U.S. Pat. No. 6,700,395 uses another approach where 3 LEDs indicate, whether the soil is wet, medium or dry. This approach also causes a battery to dissipate too quickly because one of the lights must shine at any given time

In view of the foregoing, there is a need to provide a soil moisture monitoring apparatus, which conserves battery power, indicates the degree of wetness, and is inexpensive to manufacture, and easy to use.

### OBJECTS AND ADVANTAGES

Accordingly, several objects and advantages of the invention are:
(a) to display the degree of dryness of soil in an aesthetically pleasing and non-intrusive way.
(b) to reduce battery consumption of a moisture monitoring device by displaying the degree of dryness with a slowly periodic, but brief flash of one ore more multicolor LEDs with a color hue indicative of the dryness.
(c) to reduce cost of incorporating a battery energy level indicator, by indicating battery level as a set of hues displayed on one or more of the multicolor LEDs.

Still further objects and advantages will become apparent from a consideration of the ensuing description and drawings.

### SUMMARY

In accordance with the present invention a soil moisture and dryness monitor comprises a moisture sensor, one ore more LED drivers, and one ore more multicolor LEDs.

### DRAWINGS—FIGURES

FIG. 1. is a block diagram of a water moisture monitor according to the present invention.

FIG. 2. is a perspective view of an embodiment a water moisture monitor according to the present invention.

### REFERENCE NUMERALS

| | |
|---|---|
| 10 | moisture sensor |
| 11 | LED driver |
| 12 | multicolor LED |
| 13 | external power supply |
| 14 | clear plastic over-mold |
| 15 | microcontroller |
| 16 | circuit board |

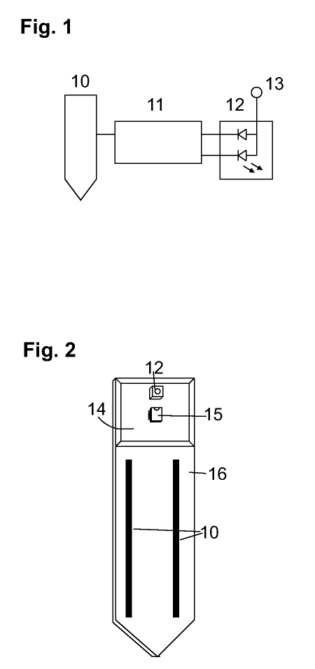

### DETAILED DESCRIPTION—FIGS. 1-2—PREFERRED EMBODIMENT

A block diagram of the preferred embodiment is described in FIG. 1. A moisture sensor 10 provides a signal proportional to the water level to the LED driver 11, which in turn drives a multicolor LED 12 with a color hue that is proportional to the signal from the moisture sensor. The circuit is powered with an external power supply or battery 13.

Numerous water moisture sensors are available that can be used for this application, including those that can be incorporated onto a PCB board; some are transmission line base, others are capacitive in nature.

Multicolor LEDs are typically composed of several closely placed LEDs which each emit one primary color form the spectrum, for example, red, green and blue. For example, if red and blue both have equal intensities, the composite signal will appear purple. Various color schemes can be used for displaying the relative moisture level of the soil. For example, a red/blue color scheme is one instance of a color scheme that could be used, where red indicates excessive dryness and blue indicates very wet soil, and varying hues of purple indicate the intermediate levels of wetness and dryness. Since multicolor LEDs have the ability to display a large continuum of information, circuit color hues could also be used to indicate battery energy levels, or other sensor parameters.

The LED driver can be implemented with a simple microcontroller. The microcontroller receives the signal from the moisture sensor, and converts it into a digital moisture level. This level is in turn used to drive the multicolor LED. The relative proportion of current through the multicolor LED determines the color hue that its internal LEDs emit. Various methods can be used to vary the current drive to the LEDs. For example, pulse width modulation (PWM) of the microcontroller's output pins can create a range of averaged output current to the LEDs, whereby a varying degree of shades and color hues can be displayed.

For the purpose of conserving power, the LED driver could be implemented such that it only turns on the LEDs after a particular dryness threshold is reached, and then only briefly flashes the LEDs at a slow period rate, at a color indicating moisture content. A microcontroller would be particularly suited for this purpose.

FIG. 2. shows a perspective view of the preferred embodiment of the moisture monitor. The sensor 10 is incorporated into a printed circuit board (PCB) 16. The sensor electronic circuit and moisture detector circuit are placed on the PCB, and enclosed in a clear plastic over-molding 14, so that the LED 12 can be seen. The LED driver is embodied as a microcontroller circuit 15.

### CONCLUSION, RAMIFICATIONS, AND SCOPE

Accordingly the reader will see that, the moisture monitor displays the degree of wetness or dryness in an aesthetically pleasing manner, in a way that conserves precious battery power.

While the above description contains many specificities, these should not be construed as limitations on the scope of the invention, but as exemplifications of the presently preferred embodiments thereof. Many other ramifications and variations are possible within the teachings of the invention. For example, a variety of the probe element types, LED configurations, and color schemes and geometries could be used.

Thus the scope of the invention should be determined by the appended claims and their legal equivalents, and not by the examples given.

What is claimed is:

1. A moisture monitoring apparatus, comprising:
a. a moisture sensor providing a signal proportional to wetness or dryness of soil,
b. an LED driver coupled to the sensor, which provides driving current proportional to the moisture sensor signal,
c. one or more multicolor LEDs, coupled to the LED driver, capable of displaying multiple color hues, whereby the level of wetness or dryness is indicated by the color hue of the LEDs.

2. A moisture monitoring apparatus according to claim 1 wherein the said LED driver modulates LED current through the use of pulse width modulation.

3. A moisture monitoring apparatus according to claim 1 wherein the LED drivers provide no current until a dryness threshold is reached, and then begin to briefly flash periodically with a given color hue.

4. A moisture monitoring apparatus according to claim 1 further comprising a battery voltage sensor, coupled to one or more of the LED drivers to drive a multicolor LED with a color proportional to the energy level of the battery.

5. A moisture monitoring apparatus according to claim 1 wherein a microcontroller acts as the LED driver by coupling to the moisture sensor, interpreting the moisture sensor signal, and driving the multicolor LEDs.

6. A moisture monitoring apparatus to claim 1 wherein the moisture sensor, and other circuit electronics are placed on a single circuit board.

7. A moisture monitoring apparatus according to claim 6 wherein the circuit board is over-molded with plastic.

8. A moisture monitoring apparatus according to claim 6 wherein the circuit board is enclosed in a watertight enclosure.

9. A method of measuring moisture of a bulk material, comprising the steps of:
a. providing a moisture sensor probe, and inserting this probe into soil which is to be monitored;
b. providing an LED driver, and modulating its output current proportionally to the signal received from the moisture sensor;
c. providing a multiplicity of multicolor LEDs coupled to the LED driver;
d. determining the dryness of the soil, and necessity of watering by viewing the color of the LEDs.

10. The method of claim 9, further comprising the steps of:
a. pulsing the current in the LED drivers of step (b) briefly and periodically after a dryness threshold is reached, whereby the LEDs are periodically flashed at a color indicative of the dryness or wetness of the soil.

11. The method of claim 9, further comprising the steps of:
a. displaying a color proportional to the energy level of the battery, on one or more of the multicolor LEDs.
